(19) United States
(12) Patent Application Publication
(10) Pub. No.: US 2015/0324060 A1
(43) Pub. Date: Nov. 12, 2015

(54) TOUCH SCREEN OVERLAY FOR MOBILE DEVICES TO FACILITATE ACCURACY AND SPEED OF DATA ENTRY

(71) Applicant: Beth Marcus, Bedford, MA (US)

(72) Inventor: Beth Marcus, Bedford, MA (US)

(21) Appl. No.: 13/732,418

(22) Filed: Jan. 1, 2013

Related U.S. Application Data
(63) Continuation of application No. 12/941,690, filed on Nov. 8, 2010, now abandoned.
(60) Provisional application No. 61/280,656, filed on Nov. 6, 2009.
(60) Provisional application No. 61/315,687, filed on Mar. 19, 2010.

(51) Int. Cl. G06F 3/041

(52) U.S. Cl. CPC G06F 3/0418

(57) ABSTRACT

A touch target array overlay that can be associated with a surface of a touch screen of a mobile or fixed device is provided. The touch target array may be translucent transparent or opaque and may have tactile features. The touch target array may include a base member and a plurality of touchable array elements. The base member may be coupled to the surface of the touch screen of the mobile device. Further, the plurality of touchable array elements may be disposed on the base member. The plurality of touchable array elements may facilitate a user to input information in the mobile device. Moreover, the plurality of touchable array elements may align with virtual keys of a virtual keypad of the mobile device, or other features.

### CROSS-REFERENCE TO RELATED APPLICATIONS

This application is a continuation of U.S. patent application Ser. No. 12/941,690 filed Nov. 8, 2010 that claims the benefit of the following provisional applications, each of which is hereby incorporated herein by reference in its entirety: U.S. Ser. No. 61/280,656 filed Nov. 6, 2009; and U.S. Ser. No. 61/315,687 filed Mar. 19, 2010.

### BACKGROUND

1. Field of the Invention

The present invention relates to providing accurate contact on a touch screen; more specifically, the invention allows improved contact by a user on a target touch screen area by directing the user contact to the center of the targeted areas on the touch screen.

2. Description of the Related Art

The main appeal of touch screen devices is the user experience. Touch screen devices are widely used primarily because they allow a user to directly interact with the device. The user interaction occurs without the need for any intermediate devices such as a stylus, a scroll-wheel, a physical keyboard, and the like. Touch screens may be found in cellular phones, personal digital assistants (PDA's), video games, satellite-based navigation devices, and the like. Typically, a touch screen is a display that detects the presence and location of a touch or contact, within an area. A touch screen device allows the user to quickly enter text, scroll through content, zoom in and out, navigate the device, and the like.

However, touch screen devices tend to suffer from a significant drawback. Since a touch screen device provides no tactile feedback related to the position being touched when a user is interacting with the screen, user input on a touch screen device usually results in a higher number of typing errors than user input on traditional input devices. The typing errors can be attributed to the close positioning of on-screen elements, such as virtual keyboards, buttons, and the like. The on-screen elements are closely positioned due to the limited size of touch screen devices and a desire to maximize the amount of information provided on the screen. In some instances, this close positioning results in a detectable touch region being potentially applicable to plurality of adjacent on-screen elements. In other words, a touch screen device may be unable to accurately and repeatedly determine which of a plurality of adjacent on-screen elements a user intended to select when touching the screen. A calibration process may be used to reduce the number of typing errors by making sure that a user's touch of the screen is mapped to particular touch regions. However, such calibration methods can lead to reduced areas of sensitivity, forcing a user to be more precise with his or her selection than is desirable. A calibration process is not an effective solution because typing errors can also be attributed to a lack of standardization of touch screen devices, screen layouts that differ from device to device and even from application to application for the same device, and the like. Some touch screen devices have attempted to approximate tactile feedback by providing a physical response that impacts a large portion of the device, such as vibrating the screen or the like when a user makes a selection. However, such methods are not effective for reducing typing errors because the feedback is only an indication that a selection was made, but does not help assure the correctness of the selection.

Additionally, it has been found that the error rate of data entry into a touch screen device increases with the speed with which data is entered the device. The error rate of data entry on a touch screen device is equivalent to the error rate of data entry on a comparable device equipped with a physical keyboard, buttons, and the like when the data is entered 50% as fast on the touch screen device. The error rate also increases for elements displayed near the edges of the touch screen, as well as when elements are displayed in portrait mode, meaning that the rectangular device is oriented in such a way so that the long sides of the device are vertical, and the shorter sides are horizontal. Portrait mode results in elements, especially keys on virtual keyboards, having to be placed closer together in order to fit on the screen which results in smaller target touch areas for each element.

A wealth of research is available regarding the size of a target touch area for virtual elements such as keys, buttons, and the like to increase accuracy during selection and data entry by a human finger. Likewise, there is data available on the range of sizes of human fingers. However, even screen elements arranged according to these data are still prone to typing errors because of the wide variation in finger sizes, screen layouts, backlights, ambient conditions, and the like. Also, requirements such as that of a full keyboard layout in portrait mode can make it impractical or impossible to lay out screen elements in accordance with optimal target touch areas. Additionally, some individuals suffer from impairments that, such as visual impairments, physical impairments, and the like, that create a different set of requirements in the use of a touch screen device.

In light of the above discussion, there exists a need for touchscreen tactile feedback that helps reduce typing errors. Such feedback for touch screen devices may decrease the input error rate by increasing the certainty that the user has selected the intended target area. Furthermore, such feedback for touch screen devices may increase user comfort, ease of use, clarity, certainty of selection, and the like, as well as speeding up data entry.

### SUMMARY

A touch target array that may be associated with a surface of a touch screen of a mobile device is provided herein. The touch target array may be translucent and may have tactile features. The touch target array may include a base member and a plurality of touchable array elements. The base member may be coupled to the mobile device so that the base member is generally in contact with the touch surface of the touch screen. Further, the plurality of touchable array elements may be disposed on the base member. The plurality of touchable array elements may facilitate a user to input information to the mobile device. Moreover, the plurality of touchable array elements may align with virtual keys of a virtual keypad of the mobile device. The base member may be composed of a flexible plastic material with depressions, projections, apertures, cut throughs, sections of varying thickness, sections of varying flexibility, etched areas, and the like. The touch target may be flexible, semi-rigid, transparent, opaque or with multiple different regions and/or a continuum of flexibilities.

The mobile device may be a mobile phone, a personal digital assistant (PDA), a media player, a GPS device, a gaming device, a navigation device, a remote control, a communicator and the like. Further, the mobile device may provide feedback to the user such as a vibration, an alert tone, and the like. The mobile device may be associated with a form factor, such as a rigid form factor, a flexible form factor, a multi-part form factor, and the like. Alternatively, the touch target array may be used with any touch screen computing display.

A method for improving accuracy of touch on a touch screen of a mobile device is described herein. The method for improving accuracy of touch may facilitate accurately capturing a specific area of the touch screen corresponding to a particular input. The method may include disposing a touch target array over a virtual keypad presented on a touch sensitive display of the mobile device. Further, the method may include calibrating alignment of the virtual keypad with the touch target array. The method may also include registering a user input by the mobile device in response to using the touch target array with the mobile device. Furthermore, the method may include receiving input feedback from the mobile device.

In embodiments, method for aligning different virtual keypads with a touch target array is provided. The method may include initiating different virtual keypad layouts on a touch screen of a mobile device. Further, the method may include selecting the appropriate virtual keypad for mapping the virtual keypad with the touch target array. The method of aligning a virtual keypad with the touch target array may alternatively include detecting an input pattern from the touch target array and selecting a virtual keypad that aligns with the touch target array providing the detected input. The method may include detecting the input pattern through the touch screen of the mobile device. The method may also include entering text in the mobile device using the touch target array. Furthermore, the method may include receiving feedback in response to entering text with the touch target array.

Methods and systems described herein may include a touch target array that includes a base member capable of being coupled to a surface of a touch screen, wherein the base member prevents a user's fingertip from contacting the touch screen; and a plurality of touchable array elements disposed in the base member, the plurality of touchable array elements configured to facilitate directing pressure from a user's fingertip to a region of the touch screen substantially below one of the plurality of touchable array elements. The touch target array may be translucent. The touch target array may have tactile features associated with each of the plurality touchable array elements. The touch target array may be further associated with a surface of a touch screen of a mobile device. The mobile device may be selected from a list consisting of: a mobile phone, a personal digital assistant (PDA), a media player, a GPS device, and a communicator. The base member may be composed of a flexible material, a semi-rigid material; it may be transparent, translucent, or opaque. The base member may include at least two areas each with a different degree of translucence.

The touch target array may include plurality of touchable array elements that are apertures that may form a distinct edge in the base member that is detectable by a human fingertip. A user may receive feedback from touching an edge of at least one of the plurality of touchable array elements. Also, at least two of the apertures may be larger than the other apertures.

Methods and systems described herein may include a method of identifying a touch target array, the method including coupling a base member to a surface of a touch screen, wherein the base member prevents a user's fingertip from contacting the touch screen; disposing a plurality of touchable array elements in the base member, the plurality of touchable array elements configured to facilitate directing pressure from a user's fingertip to a region of the touch screen substantially below one of the plurality of touchable array elements; and disposing a pattern of raised bumps extending from a backside of the base member for interfacing with the touch screen. The pattern may be detectable by software executing on a processor associated with the touch screen in response to a user pressing on the base layer opposite the pattern of raised bumps. The pattern may indicate to the software a configuration of the touchable array elements.

Methods and systems described herein may include a method for calibrating alignment of a touch target array, the method including disposing a touch target array on a touch screen; displaying a target area on the touch screen with a calibration software application; receiving input associated with one or more touchable elements of the disposed touch target array; and determining an offset between the displayed target area and a position associated with the received input with the calibration application to facilitate calibrating the touch target array with the touch screen. Optionally the method may include displaying a second target area on the touch screen; and determining an offset between the displayed second target area and a position detected through a second input associated with one or more of the touchable elements. A target area may be displayed in response to detecting a pattern provided by the touch target array due to a user pressing on the touch target array. The pattern provided by the touch target may be a pattern of raised bumps extending from a backside of the base member for interfacing with the touch screen.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

FIG. 1 illustrates a touch target array disposed on a mobile device in accordance with an embodiment of the present invention,

FIG. 2 illustrates a virtual keypad displayed on the touch screen of the mobile device, in accordance with an embodiment of the present invention,

FIG. 3 illustrates pressure being applied by a user on the touch target array, in accordance with an embodiment of the present invention,

FIG. 4 illustrates a flow diagram of a method for improving a touch on an active touch area of a touch screen of a mobile device, in accordance with an embodiment of the present invention,

FIG. 5 illustrates various dimensions of the touch target array, in accordance with an embodiment of the present invention.

FIG. 6 illustrates installation of the touch target array.

FIG. 7 illustrates a typical use of the touch target array.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” and “an,” as used herein, are defined as one or as more than one. The term “another,” as used herein, is defined as at least a second or more. The terms “including” and/or “having” as used herein, are defined as comprising (i.e., open transition). The term “coupled” or “operatively coupled,” as used herein, is defined as connected, although not necessarily directly and not necessarily mechanically.

The human finger is very sensitive to detecting an edge, more so than to detecting a raised portion of a surface (e.g. a bump). The touch target array may take advantage of this sensitivity by providing a readily detectable edge in close proximity to a preferred touch point, to establish a touchable array element. Therefore the design of a touchable array element may be optimized (e.g. in size, shape, and thickness) to establish an edge that this readily recognizable by the human finger.

An element displayed on a touch screen may cover a plurality of detectable points of contact on the touch screen. A user intending to select an element displayed on the touch screen may touch a plurality of detectable points of contact on the touch screen. The mobile device may include a means for accurately determining the actual location of the user's touch. The means for accurately determining the actual location of a user's touch may comprise one of circuitry, sensors, software, and the like. The means for accurately determining the actual location of a user's touch may include an algorithm to remove extraneous contact point data while detecting the presence and location of the touch, such as the center of pressure. Detecting the intended location (e.g. displayed element) may involve comparing the determined actual location to the center and extent of the displayed element along with the relative distance to other displayed elements. Generally, the more closely that the actual location matches the center of the displayed element, the faster and more accurately the detection of the intended location can be determined. The inventive touch target array apparatus and method disclosed herein facilitates this detection and determination process by focusing a user's touch to specific areas on the touch screen through touchable array elements.

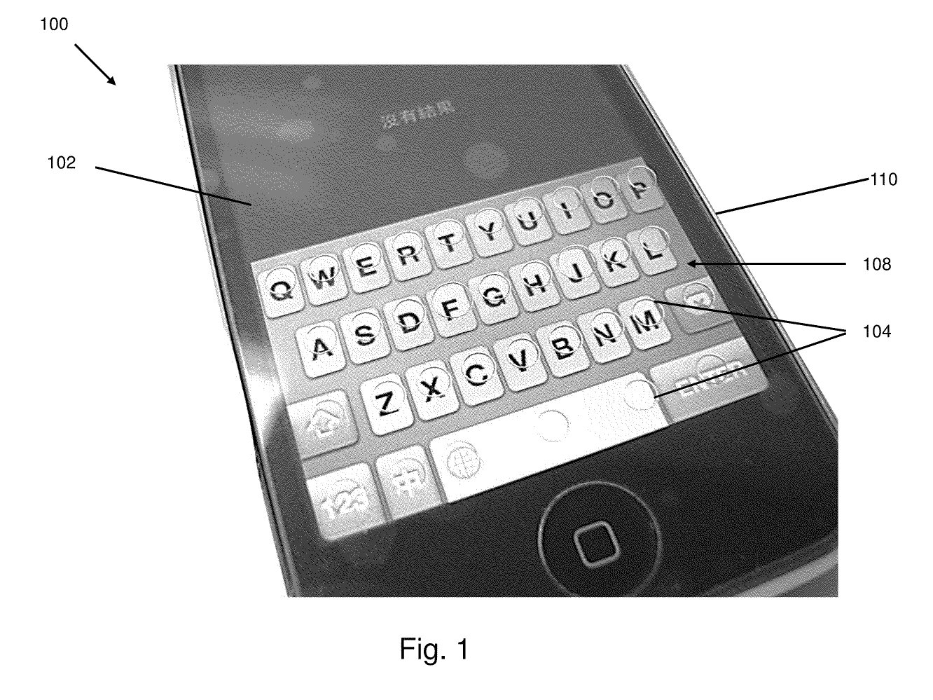

FIG. 1 illustrates a mobile device 100 that may include a display. The display of the mobile device 100 may be a touch screen 102. In addition, the touch screen 102 may display one or more elements that may be shaped like a button or key. The element may comprise a character, numeric digit, symbol, special character, and the like. A user may select the element by touching the touch screen 102 in the corresponding area where the element is displayed. A plurality of elements may be grouped together to form a virtual input map that may be used to enter related data. Such a virtual input map may be a virtual keyboard, a control panel for an application such as an audio player, navigation buttons, a graphic image, and the like. As an example, the touch screen 102 may display a virtual keyboard allowing the user to select one or more characters by touching the area of the touch screen that corresponds to the selected character. In another example, the touch screen 102 may display a control panel for an audio player. The control panel may include elements that represent actions normally associated with a music player, such as reverse, pause, stop, play, and fast forward. The user may control the audio player's actions by touching the area of the touch screen 102 that corresponds to the desired action. In another example, the virtual input map may depict animals in a farm that the user selects in response to the name of the animal being announced.

The touch screen 102 may be associated with a touch target array 108. The touch target array 108 may include a base member 110 and one or more touchable array elements 104 disposed on the base member 110. The base member 110 may be composed of a flexible, transparent material. The base material may be opaque, semi-transparent, partially transparent, shaded, patterned, and the like. The array elements may be of similar size and shape or there may be a variety of shapes or sizes in one array. The base member may be composed of a flexible plastic material with depressions, projections, apertures, cut throughs, sections of varying thickness, sections of varying flexibility, etched areas, and the like. The one or more touchable array elements 104 may provide tactile feedback to the user when the user selects an element displayed on the touch screen 102 below the touchable array element 104. The one or more touchable array elements 104 may comprise one of a depression, a protrusion, a projection, an aperture, a slot, a button, a section varying thickness, a section of varying flexibility, an etched area, and the like. The one or more touchable array elements 104 may take the shape of a circle, an ellipse, a square, a rectangle, a triangle, a line, a cross, an irregular shape, a non-symmetrical shape, and the like. The one or more touchable array elements 104 may be transparent or translucent; may include a voided portion; may include a semi-transparent or semi-translucent portion; may provide an increase in visual clarity or focus, and the like.

In an example, when the touch screen 102 displays one or more elements shaped like a button or a key, the one or more touchable array elements 104 may correspond to a touch area associated with the location of one or more elements displayed on the touch screen 102. The touch area that corresponds to the one or more touchable array elements 104 may be an area that is aligned with each of the displayed elements, such as substantially at the center of each the displayed elements.

The touch target array 108 may be used with a wide variety of touch screen shapes, such as circular, elliptical, rectangular, square or some other shape. In addition, the mobile device 100 may include circuitry, sensors, and software for processing the touch on the screen. The touch target array 108 may be used with a wide variety of touch screen technologies including 4-wire, surface acoustic wave, 5-wire, infrared, capacitive, resistive, optical, resistive arrays and other touch screen technologies may be used in the mobile device 100 without deviating from the scope and spirit of the invention.

The mobile device 100 may be any one of a number of touch screen devices such as a mobile phone, a PDA (personal digital assistant), a communicator, a tablet PC, a GPS device, a hand held device, an media player, a PMP (portable multimedia player), a notebook or laptop computer, a smart-phone, a gaming device, a navigation device, a remote control, and the like. The mobile device may include a display of any size or shape.

Alternatively, the touch target array 108 may be deployed with any type of touch screen, even for non-mobile uses. Exemplary display screens include television screens, computer screens, point of sale screens, information kiosk type screens, home security screens, visitor registration screens, automobile-based screens, screens on any type of vehicle or transportation facility (e.g. seat-back airline screens), and the like.

The mobile device 100 may be in the shape of one of a number of different form factors including bar, clamshell, flip, slide swivel and the like. These form factors represent various physical styles and designs of the mobile device 100. Further, those skilled in the art would appreciate that the form factor as described above may be addressed and/or categorized with a different terminology as included herein without deviating from the scope of the invention, including without limitation a rigid form factor, a flexible form factor, an multi-part form factor, and the like.

The touch target array 108 may be installed on to the mobile device 100 in a variety of ways including snap on/off, clamshell, two part snap together, form a device holder, integrate with an aftermarket device case, adhere to the screen through static friction, and the like.

The touch target array 108 may be added externally to the touch screen 102 or may be built in to the mobile device 100. The size, thickness, and shape of the touch target array 108 may be customized as per the design of the mobile device 100. Further, the dimensions, device attachment features, position and quantity of touchable array elements 104 of the touch target array 108 may depend on the type of mobile device, the screen size, the overall dimensions of the mobile device, the intended use environment, the features of the mobile device, and the like.

The touch target array 108 may comprise a plurality of touchable array element layouts, each suitable for a different purpose. Each touchable array element layout may match a layout of elements that may be displayed on the touch screen 102 or may take some other functional configuration. As an example, the touch target array 108 may include a layout for a landscape-oriented keyboard and a portrait oriented phone dial pad. A wide variety of other combinations of layouts may be provided by a single touch target array 108, such as, a portrait keyboard, an abbreviated keyboard, a control panel for an audio application, a gaming layout, and the like. In addition to supporting a plurality of touchable array element layouts, the touch target array 108 may be available in a variety of configurations that may depend on the design of the mobile device, the design of popular applications, standardized touch screen layouts, and the like. In this way, the touch target array 108 may allow a wide variety of users using a wide variety of applications on a wide variety of mobile devices to improve typing accuracy, speed, accommodations (e.g. for disabled users), and comfort.

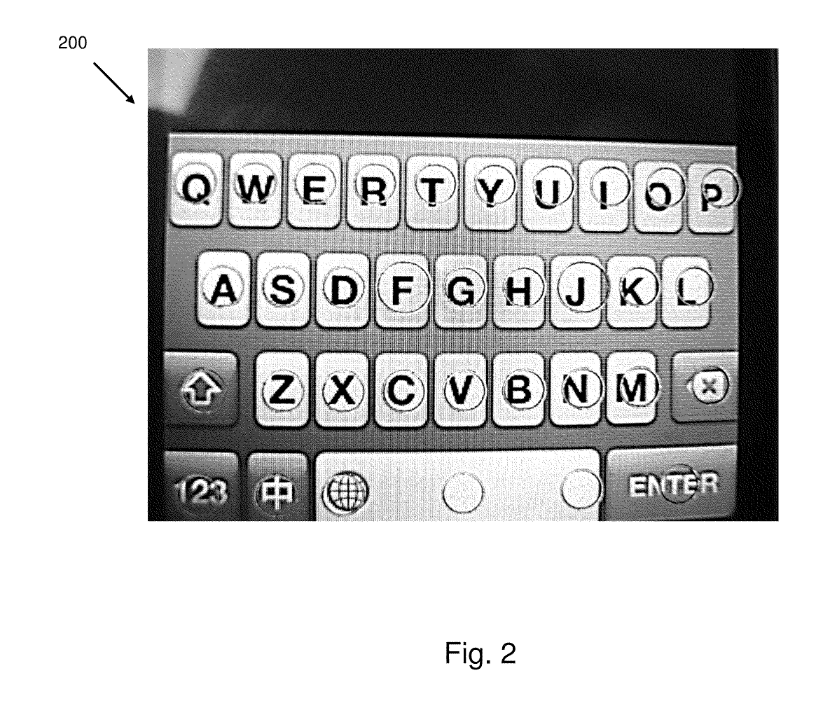

FIG. 2 illustrates a virtual keyboard 200 displayed on the touch screen 102 of the mobile device 100 with a touch target array 108 overlaid thereupon. Specifically, the virtual keyboard 200 may be a QWERTY keyboard. A QWERTY-based touch screen mobile device may have high error rates for the most frequently used letters in the English language—E, T, A, O, and I. Other high error rate letters may include ‘W’ (10%), ‘R’ (6.5%), ‘Y’ (8.7%), and ‘S’ (6.0%), which are adjacent to high-frequency use letters. Also, the letter ‘B’ (8.2%) may have a high error rate because of its location near the letter N. Hence, it may be concluded that substantially all mobile device QWERTY keys have high error rates.

The touch target array 108 may reduce the error rate during data entry by causing a force applied by a human finger or a stylus to be concentrated or centered in a specific target area of the touch screen 102. The touch target array 108 may at least partially disperse the force from a portion of the human finger 302 or the stylus that contacts the touch target array but does not contact a touchable array element 104. The touch target array 108 may allow the touch screen 102 to receive substantially all of the force from the portion of the human finger or the stylus that interacts with a touchable array element. The touchable array element 104 may facilitate concentrating forces very close to the touchable array element to be applied to the touch screen 102 in the area substantially below the touchable array element 104 while dispersing forces that are not very close to the center of to the touchable array element 104. Notably, the touch target array 108 may reduce error rates associated with virtual keys that appear near the edges of a mobile device virtual keyboard 200.

The touch target array 108 may be disposed on the surface of the touch screen 102 so that a center of an aperture of the one or more touchable array elements 104 may align with a center of a virtual key displayed on the touch screen 102. Specifically, the touch target array 108 may be positioned relative to the touch screen 102 causing a highest contact force to be nearly coincidental with the center of the virtual key that the user intended to touch. The combination of the virtual keyboard 200 displayed on the touch screen 102 and the touch target array 108 may be beneficially employed in a variety of applications including applications with notebook computers, PDAs, mobile phones, and the like.

The touch target array 108 may provide feedback to a user entering data on a mobile device 100. The feedback may be tactile and derived from a user's finger coming in contact with a touchable array element 104 while entering data. The touchable array element 104 may be configured as described elsewhere herein so that a user's finger would be able to feel contact with the touchable array element 104. The touch target array 108 may additionally increase accuracy of data entry by preventing the user from activating a displayed feature inadvertently that is not aligned with a touchable array element 104. In another example, the touch target array 108 may include touch array element discovery features (e.g. raised projections) that may initiate tactile feedback to a user to help the user determine a relative position of his/her finger(s) on the touchscreen without having to see the touchscreen.

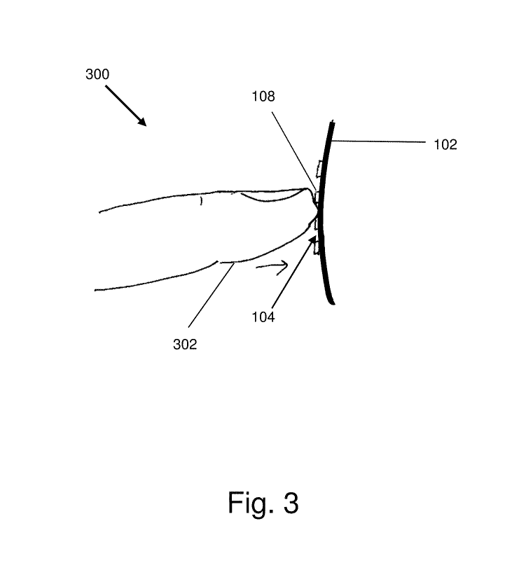

The touch target array 108 may increase accuracy of data entry on a mobile device 100 by providing a means to translate pushing actions or pressure actions into pressure on the touch screen 102 that is focused over or concentrated on a desired area. FIG. 3 illustrates a cross section of a touch target array 108 a plurality of touch array elements 104. The user's finger 302 contacts the touch target array 108 but only comes in direct contact with the touch screen 102 at the touch array element 104. When the user applies pressure to a touchable array element 104, the element facilitates transfer of that pressure to the touch screen 102. When a user applies pressure to a portion of the touch target array 108 other than a touchable array element 104, the pressure may be dissipated so that the portion of the touch screen below the user's finger (for example) registers at most a slight pressure that is insufficient to be detected as a ‘touch’. For example, referring back to FIG. 2, a user entering data on a virtual keyboard 200 would be able to apply pressure to a touchable array element 104 corresponding to the letter he wishes to select, reducing the possibility of inadvertent selection.

The touch target array 108 by its nature provides feedback to the user in response to a touch. The feedback may be tactile, audible, visual and the like. As an example, an audible beep or click may be produced whenever a selection is made using the touch target array 108 to make a selection on the touch screen 102. In another example, a slight mechanical oscillation or wobble may result from a user pressing on the pressure sensitive element 304.

The array element 304 may comprise a raised bump, tab, annular ring, hole, and any of the other types of touchable array elements 104 described herein, and the like. The array element 304 may enable the user to decrease data entry error rates by allowing the adjustment the of finger position to align with the desired input character displayed on touch screen 102. The array element 304 may also provide a mechanical feedback when pressed by compressing the array element 304 between the user's finger 302 and the touch screen 102. When the user's finger 302 is lifted from the array element 304, the array element 304 may uncompress, providing a feedback similar to a mechanical keyboard, a button, and the like.

The touch target array 108 may allow a visually impaired user to efficiently interact with a mobile device 100 that contains a touch screen 102. The feedback provided by the touch target array 108 may guide a user to enter data on a touch screen 102 without the need for constant visual verification by the user. The touch target array 108 may be configured for use by people with impairments, such as by varying the characteristics of the touch target array (e.g. stiffness, shape, detente, touchable array element spacing, and the like. Similarly, the touch target array 108 may be configured for a variety of users based on user age, size of hand, gender and the like.

The touch target array 108 may include mechanical switches. These switches may enable the user to feel tactile features including spring action for feedback thereby improving the layout of the touch target array 108. Mechanical switches may interact with features of the mobile device other than the touch screen, such as a power on/off button, a screen lock/unlock button, application home button, and the like. The mechanical switches of the touch target array 108 may be aligned with the other features of the mobile device.

Although generally described herein as being applied for interacting with a touch screen, the touch target array 108 may be configured to also facilitate interacting with other touch sensitive features of a device, such as mechanical switches (e.g. a power on/off switch) on the top and/or sides of the device. Because the overlay may be configured to fit around a device, touch sensitive features on the back of the mobile device may also be serviced by the touch target array 108.

Touchable array elements 104 may be constructed of various materials including plastic, elastomeric foam, metal, composite materials (e.g. elastomeric and carbon fiber), and the like. Alternatively touch elements 104 may be constructed as a flexible membrane encasing a spring or snap-action type element that transmits a user touch on a top surface to a bottom surface that may be in contact with or very close to the touch screen. The spring or snap-action type element may redirect the user touch force to a more precise and smaller region of the touch screen than if the user touched the touch screen directly. The spring or snap-action type element may react to a user touching a top surface of the encapsulation by forcing a portion of the lower surface of the encapsulation to deform and make contact with the touch screen.

The touch target array 108 may work cooperatively with the mobile device (and/or software executing on the mobile device) to enhance feedback to the user. In addition to mechanical tactile feedback from the touchable array elements 104 of the touch target array 108, software executing on the device may, in response to detecting a touch of one of the touchable array elements 104, provide a visual indication of feedback, such as increasing the brightness of the display region below the detected touchable array element, thereby effectively causing the touchable array element 104 to be highlighted. Other visual indications may also be cooperatively provided and are included herein, such as without limitation changing color, intensity, size, shape, image, and the like. Even within a given software application, different touch arrays could be easily swapped to correspond to different functions of the program, for example a data entry task might have one layout of array elements, while a data checking task another.

The touch target array 108 may be used to limit a user's ability to select elements displayed on touch screen 102. The touch target array 108 may be arranged so that only an element needed to perform a certain function can be selected. As an example, a touch target array 108 may be used to allow a child to play a game on a mobile device 100 while making sure that the child may not select any virtual elements displayed on touch screen 102 that are not necessary for game play. The touch target array 108 may accomplish this type of limiting with configurations that include touch elements 104 positioned over only the allowed elements. Alternatively a touch target array 108 may be configured with opaque areas that obscure functions that are restricted. In this way, the same application may be used by an advanced user and by a novice user simply by interchanging the touch target array 108.

The touch target array 108 may include an identification region that may comprise a unique pattern of bumps that make contact with the touch screen. The identification region may be configured with a different pattern of bumps or other shapes detectable by the human finger for that identifies the configuration of the touch target array 108. This may facilitate software applications on a mobile device to identify the touch target array configuration currently being used with the mobile device. In an example, when this region is pressed by a user, the pattern of bumps may impact touch sensitive areas of the touch screen that may be detected by the device and communicated to device software, such as user interface applications. The device software may determine the pattern of touchable array elements 104 on the detected touch target array 108 based on the identification region pattern. This may allow device software to present a display on the touch screen that matches well to the configuration of touch target array 108 being used. In an example, a device application may support full function and partial function modes of operation. When a touch target array 108 that supports full function mode is detected, a full function touch screen display may be presented. Similarly, if a partial function mode touch target array 108 is detected, the application may display only the partial function features. This may be beneficially applied for differentiating among expert and novice users, free and paid-up users, child and adult users, and the like. In another mode the pattern would be recognized by the software on the device and when a finger presses against the pattern the device could launch a particular application or function (i.e. the camera or speaker or specific application like a particular game).

Alternatively, the identification region may be used to activate a particular mobile device application. In an example, a user may install a gaming touch target array 108 and activate the identification region. The mobile device may detect the newly installed touch target array 108 through sensing the identification region and launch a gaming application. The user may then switch to a word processing touch target array 108 and activate the identification region, causing the mobile device to launch a work processing application.

In situations where an underlying application that cannot customize a display is being used, an intermediate program may be used to control the display and pass touch information to the underlying application that accurately indicates to the application which function (e.g. with virtual key) has been selected by the user.

Software for calibrating the touch screen 102 may be programmed to adapt itself to touch target array 108 through the use of the identification region described above. The calibration software of the mobile device 100 may be programmed to change calibration of the active region of the touch screen 102 based on the touch target array 108 that is being used without having to require the user to run a separate calibration function. Calibration software may run in the background and may record touches made with a touch target array 108 to continuously align the display of underlying symbols or virtual keypads and therefore valid recognition of user touches.

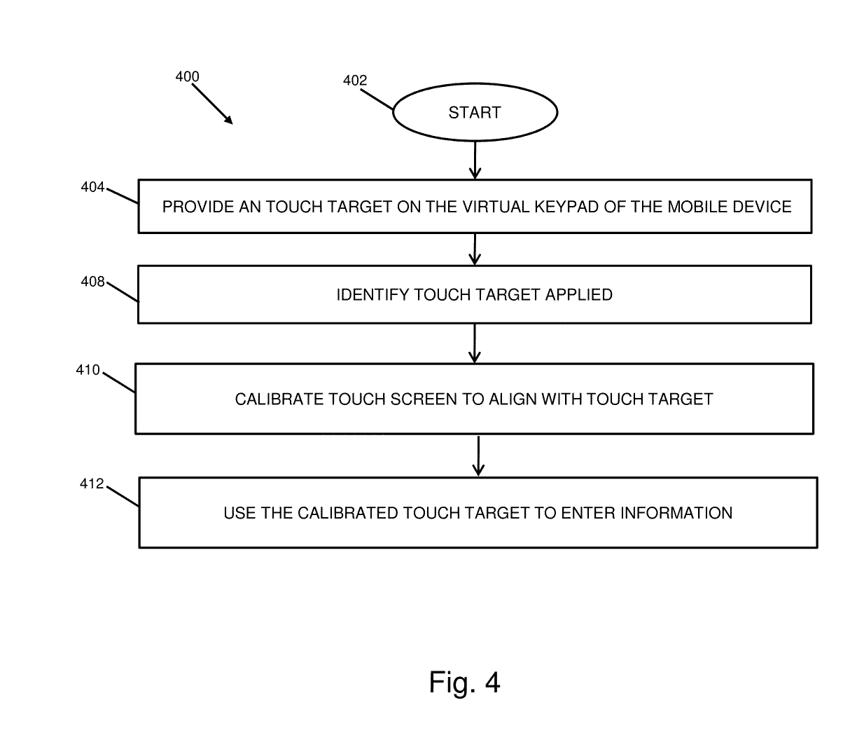

Although the device by its nature improves accuracy and reduces error rate by taking advantage of the human's ability to feel shapes through the fingers, it is possible to develop a variety of schemes using the present invention to further enhance performance. FIG. 4 represents a flow diagram for using a touch target array 108 to improve data entry and reduce the error rate of entering data on the touch screen 102 of the mobile device 100. The process 400 initiates at step 402 and immediately moves to step 404. At step 404, the touch target array 108 may be provided over the virtual keypad 200 of the mobile device 100. Alternatively, the touch target array 108 may already be installed on the mobile device and step 404 may be skipped. At step 408, the user may be presented with a choice of touch target array configurations 108 on the display of the mobile device from which the user may select entry that matches the touch target array 108 applied. Alternatively, the user may activate the identification region by pressing on it and the mobile device may determine which configuration of touch target array 108 is applied. Yet alternatively to this, a default touch target array 108 configuration may be assumed by the device application and this step may be skipped. Next the calibrate step 410 may utilize a software program installed on mobile device 100 to facilitate aligning the touch screen to the applied touch target array 108 by instructing the user to touch the touch target array 108 at various touchable array elements 104 to properly line up the touch screen 102 with the touch target array. Calibration may continue if alignment cannot be initially confirmed and the user may be instructed to verify the proper installation of and selected configuration of the touch target array 108. The process may continue with step 412 in which the user may proceed to use the touch target array 108 to enter data on touch screen 102.

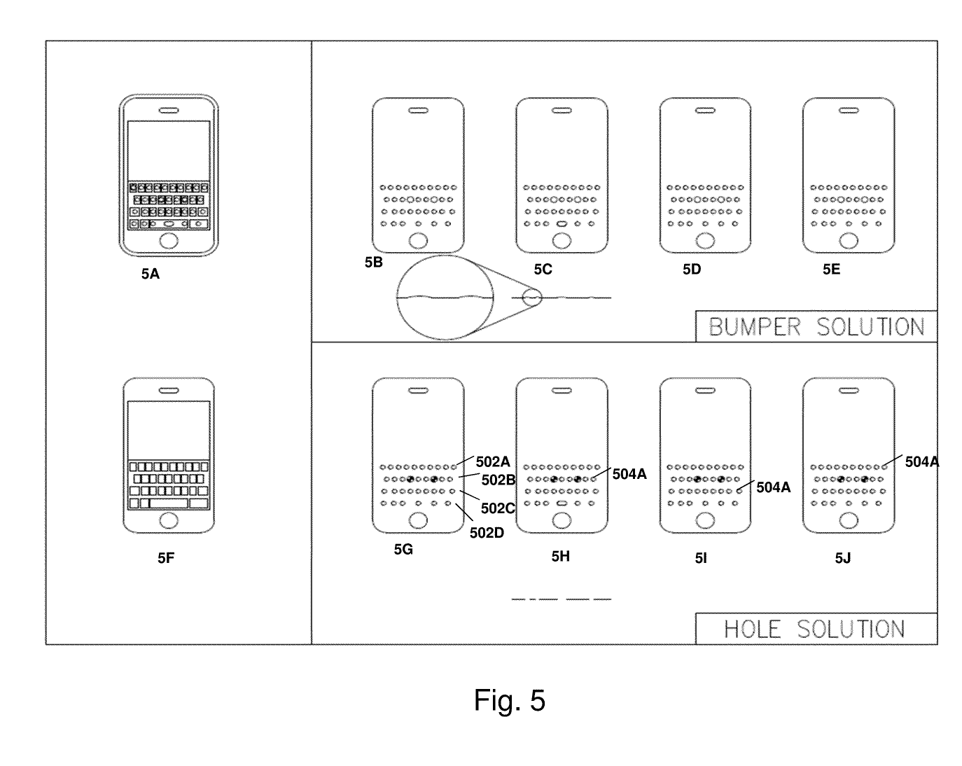

FIG. 5 describes several examples of a subset of possible touch target array 108 implementations. In the two embodiments depicted in FIG. 5, the touch target array 108 may be implemented using a bumper or protrusion solution, or a hole or aperture solution. The touch target array 108 may have various dimensions, some of which are shown in FIG. 5. In this embodiment, the touch target array 108 may include a plurality of rows and columns of touchable array elements 104 arranged generally to align with the layout of elements displayable on the touch screen 102 of the mobile device 100.

Referring to FIG. 5, embodiments. 5A, 5B, 5C, 5D, and 5E of the touch target array 108 include touchable array elements 104 in the form of bumps or protrusions (e.g. nubs). In these embodiments, the base member 110 may include bulging projections such as nubs/protrusions that comprise the touchable array elements 104, such as for providing tactile feedback when information is entered using the touch target array 108.

Referring again to FIG. 5, the touch target array 108 may alternatively include a plurality of touchable array elements 104 that may comprise holes as illustrated in embodiments. 5E, 5F, 5G, 5H, 5I, and 5J. Each row of the touch target array 108 such as 502A may include one or more holes; multiple rows of holes such as that in 502A, 502B, 502C and 502D may be parallel to each other as shown in FIG. 5. In embodiments, one or more holes such as 504A may be laid out to align with the arrangement of elements displayed on touch screen 102 of the mobile device 100. For example, the touch target array 108 may include ten holes in the first row. The holes may be separated from each other by a specified distance. Continuing with the above example, the distance between the center of the first hole and the center of the tenth hole may be around 44.55 mm. Similarly, the distance between the center of the second hole and the center of the ninth hole may be 34.55 mm. The center of the third hole and the center of the eighth hole may be separated by a distance of 24.75 mm. Furthermore, the distance between the center of the fourth hole and the center of the seventh hole may be 14.85 mm. The two adjacent holes of the first row, that is the fifth and the sixth hole, may be separated by a distance of 4.95 mm from center to center. The one or more holes embedded on the touch target array 108 may have different diameters. As shown in FIG. 5, the touch target array 108 may have holes with diameters of 3.00 mm and/or 4.00 mm. Further, those skilled in the art may construe that the touch target array 108 may have alternative arrangements and dimensions without deviating from the scope and spirit of the invention.

Further, the touch target array 108 may be aligned with the touch screen 102 of the mobile device 100 such that the virtual keypad/hole pad may be aligned with the touch target array 108 for optimum operation. Moreover, the touch target array 108 may include a second row of holes having nine holes. As discussed above, these holes may be separated by a fixed distance between them. For example, the distance between the center of first hole and the ninth hole may be 39.60 mm. Similarly, the distance between the center of the second and the center of the eighth hole may be 29.70 mm. Likewise, the distance between the center of the third hole and the center of the seventh hole of the second row may be 19.80 mm. Moreover, the distance between the center of the fourth and the center of the fourth last hole of the second row may be around 9.90 mm. Further, the fifth hole may be located on the longitudinal axis dividing the touch target array 108 into two equal halves.

The touch target array 108 may include nine holes in the third row. The distance between the center of the first hole and the center of the ninth hole may be 42.55 mm. Similarly, the distance between the center of the second hole and the center of the eighth hole may be 29.70 mm. Further, the distance between the center of the third hole and the center of seventh hole may be 19.80 mm. Furthermore, the distance between the center of the fourth hole and the center of the sixth hole may be 9.90 mm. Further, the longitudinal axis of the overlay may pass through the fifth hole of the third row.

In another exemplary embodiment, the touch target array 108 may include a fourth row of holes. The fourth row may include six holes; the distance between the center of the first hole and the hole located at the end of the longitudinal axis may be about 21.78 mm. Moreover, the distance between the center of the second hole and the center of the sixth hole may be about 33.91 mm.

In other embodiments, the dimension may be obtained in collaboration with the manufacturer of the mobile device 100 and may be defined according to the layout of the hole-pad, hole-board, virtual holes, and the like. The holes 504A may be circular, rectangular, triangular, octagonal, and any of the other shapes described herein and elsewhere, and the like. Further, the holes may have various and varying shapes. The holes 504A may be sized to accommodate a range of user finger sizes.

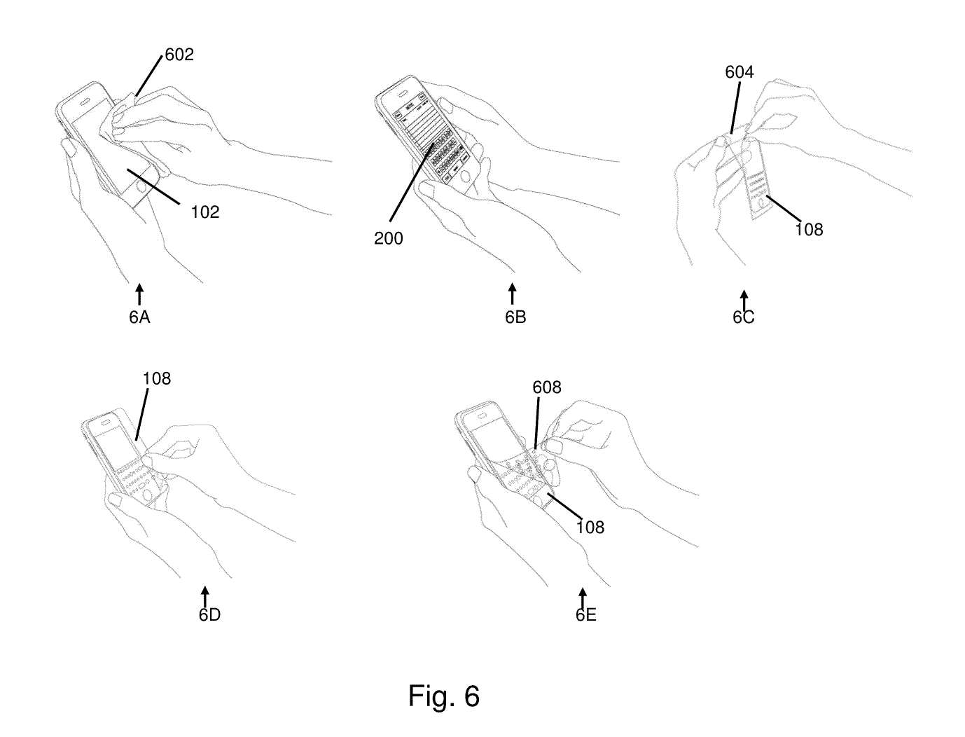

FIG. 6 illustrates a process for installation of the touch target array 108. Embodiment. 6A, 6B, 6C, 6D, and 6E illustrate a sequence of different steps involved in the installation of the touch target array 108 on a mobile device. Although the installation process example in FIG. 6 depicts installation of the touch target array 108 on a mobile device, the installation process may be substantially similar for other touch screen devices including other mobile devices, handheld devices, stationary devices, large screen devices, desktop displays, point of sale screens, kiosk screens, and any other device with a suitable touch screen display. The process of installation depicted in FIG. 6 may include a user installing the touch target array 108 on a mobile device in a sequential manner.

Referring to embodiment 6A, a user may clean the touch screen 102 of the mobile device before installing the touch target array 108. In embodiments, a cleaning cloth 602 may be used for the purpose of cleaning the touch screen 102. The threads of the cleaning cloth 602 may be split into microfibers and woven into small loops allowing the cleaning cloth 602 to trap and remove particles off the touch screen surface. Further, the cleaning cloth 602 may remove smudges and fingerprints without scratching the touch screen 102 of the mobile device. Cleaning the touch screen may facilitate high quality adherence of the touch target array 108 to the touch screen.

Further, in embodiment 6B, the user may display a desired keypad or other user interface display of the mobile device on the touch screen 102 before installing the touch target array 108. This may help the user visually ensure alignment of the touch target array 108 with the desired user interface function.

Referring to embodiment 6C, the user may remove the touch target array 108 from the backing envelope sheet 604 revealing a backing side of the touch target array 108 which may have an adherence finish to provide cushioning and/or protection to the touch screen 102. The adherence finish may be an anti-scratch coating layer, an anti-glare PET plastic layer, a residue-free silicone coating, and the like. In embodiments, an anti-scratch coating finish may protect the touch screen 102 from fingerprints, smudges, and scratches. Further, an anti-glare PET finish may reduce the glare caused by sunlight and fluorescent lighting, thereby allowing the use of the mobile device indoors under bright office lights or outdoors under bright sunlight. Additionally, glare reduction may help reduce some effects of eye strain caused by spending long hours viewing the touch screen 102. A silicone finish used in the touch target array 108 may serve the purpose of adherence to the touch screen 102.

Further, as shown in embodiments 6D and 6E, the user may attach the touch target array 108 over the touch screen 102. The size, thickness, and shape of the touch target array 108 may be customized as per the design of the mobile device. Further, the dimensions, device attachment features, position and quantity of touchable array elements 104 of the touch target array 108 may depend on the type of mobile device, the screen size, the overall dimensions of the mobile device, the intended use environment, the features of the mobile device, and the like.

In embodiments, the user may dispose the touch target array 108 on the surface of the touch screen 102 so that the center of the aperture of the one or more touchable array elements 104 may align with a center of a virtual key that may be displayed as noted in embodiment 6B. Upon completion of the installation of the touch target array 108, the user may remove protective film 608, leaving the touch target array 108 in position to make the touch target array 108 ready for use with the touch screen 102.

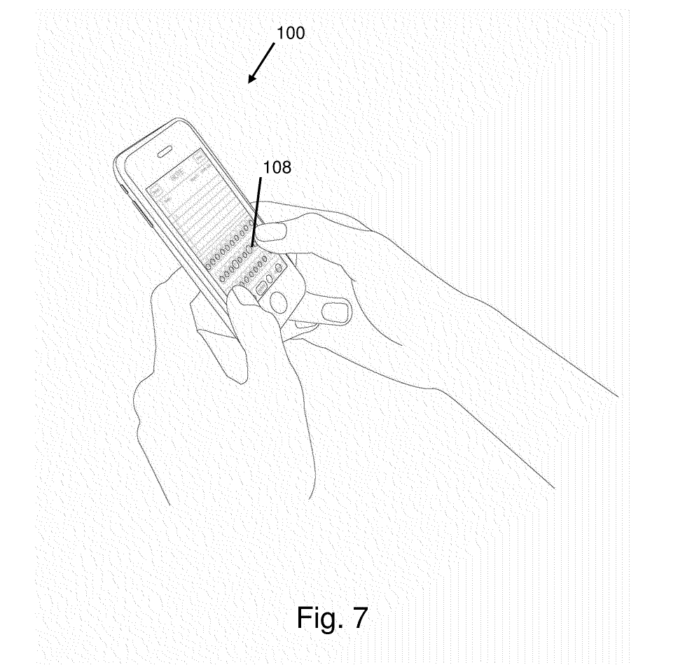

FIG. 7 illustrates a typical use of the touch target array 108 with a mobile device. The user can manipulate the touch screen 102 of the mobile device with his or her finger(s) and/or thumbs easily and reliably using the touch target array 108. Note that the touch target array 108 embodiment of FIG. 7 allows the user to have a clear unobstructed view of the touch screen while providing the many benefits and features described herein.

Uses of the touch target array 108 include business applications such as for filing in forms for inventory management. By configuring the touch target array to align with a business form, data entry and inventory management (e.g. determining stocking levels on store shelves) may be made easier and faster. Entering information in a number pad format may be enhanced with the touch target array 108. The touch target array 108 may be used to standardize the location of certain common function buttons such as a ‘dial’ button by subtly differentiating a touchable array element 104 for the dial function. Alternatively, the touch target array 108 may be configured with games, such as golf or bowling and other games that require a user to aim by selecting a point on the display so that the user can more readily avoid touching two nearby aiming points that may cause the user to miss the intended target.

Combining a touch target array 108 with any touch screen may enable use of the touch screen for new applications. In an example, a touch screen with a touch target array 108 may be configured to operate as a remote keypad for a home security system. In the example, a user may apply a home security controller configuration of the touch target array 108 to a touch screen device, such as the user's mobile phone and activate a home security control function through the identification region of the touch target array 108. The home security configuration of the touch target array 108 may include a plurality of uniquely shaped touchable array elements 104 that when pressed instruct the home security control application to perform a specific function. The mobile phone may be then placed at the bedside of a user so that the user can readily control home security features without having to see the touch screen clearly by virtue of the touchable array elements 104 being configured to be individually detectable by touch alone.

The touch target array 108 may be configured to attach to a touch screen device and swing out of the way of the touch screen while remaining attached to the device. This may emulate some touch screen devices that also include a moveable keyboard. However, instead of requiring the additional costs and manufacturing complexity of both a touch screen and a separate electrically powered keyboard, the touch target array 108 may swing out of the way (e.g. swing around to the back of the mobile device) when not needed. This may significantly simplify the cost and complexity of touch screen based mobile devices without reducing the flexibility and features of the touch target array 108 as described herein.

Languages with many unique characters, such as Kanji, Traditional Chinese, and the like may be difficult to use on a limited area touch screen due to the small size required to display a sufficient quantity of characters. A human finger may not be able to accurately and repeatably touch such small area. However, with the touch target array 108 transferring the user's finger touch to a more focused area on the touch screen, use of such languages may be readily enabled on a small area touch screen device.

The touch target array 108 also may facilitate branding through marking the touch target array 108. Branding may include semi-transparent text, images, and the like that may minimally impact a user's ability to see content displayed on the touch screen. Alternatively, a portion of the touch target array 108, such as along a border of the touch screen or on a portion that interfaces with the case of the mobile device may be marked with a brand. Marking may also include etching, sublimation, or other techniques in addition to printing (e.g. pad printing) and the like. The touch target array may also be configured with a fully exposed area for branding presented on the touch screen display to show through the touch target array 108. A software application may optionally display branding in more one of a variety of positions based on the touch target array 108 that is used with the application.

Applications of the touch target array 108 may include, without limitation, text entry applications, number pad applications, application remapping, custom user mapping, gaming, maps, media, dial pad, rotary-type interface for a media player, music controller, domain-specific uses (e.g. a YouTube configuration), phone capabilities, mobile software, forms, gloved environments, disabled or impaired users, children, animals, and the like.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A touch target array, comprising:
a base member capable of being coupled to a surface of a touch screen, wherein the base member prevents a user's fingertip from contacting the touch screen; and
a plurality of touchable array elements disposed in the base member, the plurality of touchable array elements configured to facilitate directing pressure from a user's fingertip to a region of the touch screen substantially below one of the plurality of touchable array elements.

2. The touch target array of claim 1 being translucent.

3. The touch target array of claim 1 having tactile features associated with each of the plurality touchable array elements.

4. The touch target array of claim 1, further associated with a surface of a touch screen of a mobile device.

5. The touch target array of claim 4, wherein the mobile device is selected from a list consisting of: a mobile phone, a personal digital assistant (PDA), a media player, a GPS device, and a communicator.

6. The touch target array of claim 1, wherein the base member is composed of a flexible material.

7. The touch target array of claim 1, wherein the base member is composed of a semi-rigid material.

8. The touch target array of claim 1, wherein the base member is one of transparent, translucent, and opaque.

9. The touch target array of claim 1, wherein the base member comprises at least two areas each with a different degree of translucence.

10. The touch target array of claim 1, wherein the plurality of touchable array elements comprise apertures.

11. The touch target array of claim 10, wherein the apertures form a distinct edge in the base member that is detectable by a human fingertip.

12. The touch target array of claim 11, wherein a user receives feedback from touching an edge of at least one of the plurality of touchable array elements.

13. The touch target array of claim 10, wherein at least two of the apertures are larger than the other apertures.

14. A method of identifying a touch target array, comprising:
coupling a base member to a surface of a touch screen, wherein the base member prevents a user's fingertip from contacting the touch screen;
disposing a plurality of touchable array elements in the base member, the plurality of touchable array elements configured to facilitate directing pressure from a user's fingertip to a region of the touch screen substantially below one of the plurality of touchable array elements; and
disposing a pattern of raised bumps extending from a backside of the base member for interfacing with the touch screen.

15. The method of claim 14, wherein the pattern is detectable by software executing on a processor associated with the touch screen in response to a user pressing on the base layer opposite the pattern of raised bumps.

16. The method claim 15, wherein the pattern that is detectable indicates to the software a configuration of the touchable array elements.

17. A method for calibrating alignment of a touch target array, comprising:
disposing a touch target array on a touch screen;
displaying a target area on the touch screen with a calibration software application;
receiving input associated with one or more touchable elements of the disposed touch target array; and
calculating an offset between the displayed target area and a position associated with the received input with the calibration application to facilitate calibrating the touch target array with the touch screen.

18. The method of claim 17, further including displaying a second target area on the touch screen; and determining an offset between the displayed second target area and a position detected through a second input associated with one or more of the touchable elements.

19. The method of claim 17, wherein displaying a target area is in response to detecting a pattern provided by the touch target array due to a user pressing on the touch target array.

20. The method of claim 19, wherein the pattern provided by the touch target is a pattern of raised bumps extending from a backside of the touch target array for interfacing with the touch screen.
